(19) United States
(12) Patent Application Publication
(10) Pub. No.: US 2011/0291043 A1
(43) Pub. Date: Dec. 1, 2011

(54) Aluminum Substituted Mixed Transition Metal Oxide Cathode Materials for Lithium Ion Batteries

(75) Inventors: James D. Wilcox, Pleasanton, CA (US); Marca M. Doeff, Hayward, CA (US)

(73) Assignee: The Regents of the University of California, Oakland, CA (US)

(21) Appl. No.: 13/119,703

(22) PCT Filed: Sep. 23, 2009
(86) PCT No.: PCT/US09/58073

§ 371 Date: Jun. 30, 2011

Related U.S. Application Data
(60) Provisional application No. 61/099,649, filed on Sep. 24, 2008.

(51) Int. Cl. H01M 4/525

(52) U.S. Cl. 252/182.1

(57) ABSTRACT

A mixed transition metal oxide is provided described wherein Aluminum is partially substituted for Cobalt in a Li[NiₓCo_{y}Mn_{z}]O₂ composition wherein the resulting aluminum substituted product Li[Ni_{0.4}Co_{0.2-y}Al_{y}Mn_{0.4}]O₂ is less costly than the parent product, is safer to use, and provides enhanced electrochemical performance as a cathode material for use in Lithium-ion based batteries.

### CROSS REFERENCE TO RELATED CASES

This application claims priority to PCT Application PCT/US2009/058073, filed Sep. 23, 2009, which application in turn claims priority under 35 USC 119 (e) to Provisional U.S. Patent Application Ser. No. 61/099,649 filed Sep. 24, 2008, the contents of which applications are incorporated herein by reference as if fully set forth in their entirety.

### STATEMENT OF GOVERNMENTAL SUPPORT

The invention described and claimed herein was made in part utilizing funds supplied by the U.S. Department of Energy under Contract No. DE-AC02-05CH11231. The government has certain rights in this invention.

### BACKGROUND OF THE INVENTION

1. Field of the Invention

This invention relates generally to lithium ion batteries, and, more specifically, to improved lithiated compositions containing defined amounts of aluminum for use as cathode materials in such batteries.

2. Description of the Related Art

Plug-in hybrid electric vehicles require batteries with higher energy density and power than are currently available from existing nickel metal hydride systems. Lithium ion batteries are the most promising candidates for this transition, but high cost and concerns about safety present significant impediments. Currently, battery companies are using LiCoO₂ as a preferred cathode material in consumer batteries. Due to the high cost of Co, however, (currently about $50/lb), and given the fact the cost of the cathode represents up to 60% of battery cost (depending on cell design), reduction of the amount of Co using less expensive substituents has been considered. Thus, battery companies are now looking to replace LiCoO₂ with mixed transition metal oxides, such as Li[NiₓCo_{y}Mn_{z}]O₂, in devices intended for vehicular applications.

With Li[NiₓCo_{y}Mn_{z}]O₂, the various metals perform different functions. The presence of Mn lowers costs substantially (the raw Mn materials are fractions of a cent per pound), but Mn is not electroactive for this type of layered structure. Thus, one cannot increase Mn content substantially as this lowers energy density. The Ni²⁺⇄Ni⁴⁺ couple is redox active at potentials relevant to the normal operation of batteries, but high Ni content is associated with a decrease in rate capability (power). This is due to “ion mixing”, in which a portion of the Ni ions are located at lithium sites, blocking the diffusion of lithium ions. The presence of Co decreases ion mixing, but substantially increases cost. Furthermore, Co is electroactive only at high potentials (mostly above the oxidative stability limit of the electrolyte).

Of mixed transition metal oxide formulations which have been explored, Li[Ni_{1/3}Co_{1/3}Mn_{1/3}]O₂ has been found to exhibit good performance but is still too expensive. Another formulation, Li[Ni_{0.4}Co_{0.2}Mn_{0.4}]O₂, while less expensive, suffers from low power capability. Thus, there remains a need to develop a material cheaper than Li[NiₓCo_{y}Mn_{z}]O₂ while retaining the performance characteristics necessary for plug-in hybrid applications.

### SUMMARY OF THE INVENTION

It has been found that the addition of limited amounts of aluminum metal to the Li[NiₓCo_{y}Mn_{z}]O₂ formulation leads to significant cost reductions while at the same time provides improvements relative to safety and battery performance. More particularly both Li[Ni_{1/3}Co_{1/3-y}Al_{y}Mn_{1/3}]O₂ and Li[Ni_{0.4}Co_{0.2-y}Al_{y}Mn_{0.4}]O₂ and Li[Ni_{0.4}Co_{0.2-y}Al_{y}Mn_{0.4}]O₂ compounds where (0<y≦0.2) have been found to provide such enumerated improvements, with best results obtained for the latter formulation. Although high Al contents do lower practical capacity because Al substitution shifts the cycling profile to higher voltages, there is little impact at low current densities for y≦0.05. For such Al-substituted compounds, and most dramatically where y=0.05, large increases in rate capability are observed. Almost no capacity is obtained when cells containing the parent compound, Li[Ni_{0.4}Co_{0.2}Mn_{0.4}]O₂, (y=0) are discharged at 4-5 mA/cm², illustrating the low power capability associated with such cathode. By way of contrast, cells containing the lithiated compound where the Al content is near five mole percent delivers in the order of ten times the capacity at these high rates. This result was surprising in view of the prediction by Kang and Ceder, Phys. Rev. B 74, 094105 (2006) for layered oxides containing Al that there would actually be a decrease in lithium ion mobility.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 is a plot of Powder X-Ray Diffraction (XRD) patterns for a Li[Ni_{0.4}Co_{0.02-y}Al_{y}Mn0.4]O₂ series.

FIG. 2 includes plots of lattice parameters as a function of Al content.

FIG. 3 is a plot of the c/3a ratio for various amounts of Al content.

FIG. 4 is a TEM image of Li[Ni_{0.4}Co_{0.2}Mn_{0.4}]O₂ and a TEM image where the Co has been replaced completely by Aluminum.

FIG. 5 is a plot of differential capacity vs. cell potential for various Al levels.

FIG. 6 is a plot of discharge capacity vs. number of cycles for various Al levels.

FIG. 7 is a plot of discharge capacity vs. current density for Li[Ni_{0.4}Co_{0.2-y}Al_{y}Mn_{0.4}]O₂, for varying concentrations of Al.

FIG. 8 is a plot of discharge profiles for two lithium cells containing Li[Ni_{0.4}Co_{0.2-y}Al_{y}Mn_{0.4}]O₂, where y=0.2 and y=0.0.

### DETAILED DESCRIPTION OF THE INVENTION

By way of this invention, the improved electrochemical performance of Al substitution of mixed transition metal oxides is demonstrated, with the goal of further reducing the cobalt content realized. Because most of the Co is not redox active until high potentials vs. Li are reached, partial replacement with electrochemically inactive Al at low levels generally was found to have minimal impact on capacity under normal cycling conditions. Partial or full replacement of Co with Al resulted in much higher rate capability at all levels, but capacity below 4.3V vs. Li was decreased for high Al contents.

### Experimental

The aluminum substituted compounds can be synthesized using the glycine nitrate combustion process. For this method, stiochiometric mixtures of LiNO₃ (Mallinckrodt), Mn(NO₃)₂ (45-50 wt. % in dilute nitric acid, Sigma Aldrich), Co(NO₃)₂-6H₂O (98%, Sigma Aldrich), Ni(NO₃)₂-6H₂O (Sigma Aldrich), and Al(NO₃)₃-9H₂O (98+%, Sigma Aldrich) are dissolved in a minimum amount of a solvent such as distilled water. A slight (5%) excess of lithium nitrate may be included to accommodate lithium loss during synthesis. Using combustion synthesis techniques, a fuel such as glycine, citric acid, urea, etc. is now added to the obtained solution. (The ratio of the fuel to nitrate components will determine combustion temperature.) The resulting solution is then dehydrated on a hot plate in a stainless steel vessel until auto-ignition occurs. The resulting powders are collected and wet or dry milled until homogeneous. Thereafter the material is heated at temperatures between 700° C. and 1000° C. in air or under oxygen until crystallization in the layered structure is completed. In an exemplary embodiment, glycine was used as the fuel, and added so that the glycine to nitrate ratio was 0.5. The powders were then planetary ball milled for one hour in acetone, and dried under flowing nitrogen before being fired at 800° C. (4° C./min heating rate) for four hours in air.

Alternatively, the addition of the fuel to the solution of nitrate precursors can be omitted, in which case the solution is simply concentrated by gentle heating to reduce the volume until a gel or paste forms. This product is then fired to form the desired final product. More particularly in this non-combustion process, the soluble metal containing precursors such as nitrates, acetates, oxalates, etc are dissolved in a suitable solvent such as water, alcohol, and the like. The solution is then heated until it is concentrated to a small volume, high viscosity paste or gel. Thereafter the material is heated at temperatures between 700° C. and 1000° C. in air or under oxygen until crystallization in the layered structure is completed.

Laminate composite cathodes were formed, comprised of 84% active material (Li[Ni_{0.4}Co_{0.2-y}Al_{y}Mn_{0.4]}O₂, wherein y is between greater than 0.00 and 0.20), 8% poly(vinylidine fluoride) (PVDF, Kureha Chemical Ind. Co. Ltd.), 4 wt. % compressed acetylene black, and 4 wt. % SFG-6 synthetic flake graphite (Timcal Ltd., Graphites and Technologies) were applied to carbon coated current collectors (Intelicoat Technologies) by automated doctor blade. Electrodes of 1.8 cm² having an average loading of 7-10 mg/cm² of active material were punched out. Coin cells (2032) were assembled in a helium filled glove box with a lithium metal anode and 1M LiPF₆ in 1:2 ethylene carbonate/dimethyl carbonate (EC/DMC) electrolyte solution (Ferro). Galvanostatic cycling was carried out on an Arbin BT/HSP-2043 cycler between limits of 2.0 and 4.3-4.7V. All cells were charged at a current density of 0.1 mA/cm² independent of the discharge rate.

Powder X-ray diffraction (XRD) was performed on a Phillips X'Pert diffractometer with an X'celerator detector using Cu Kα radiation to determine phase purity. A back loading powder holder was used to minimize the impact of any preferred orientation. Unit cell parameters were obtained from the patterns using the software package FullProf. Particle morphology was examined using transmission electron microscopy (TEM) on a Phillips CM200FEG (field emission gun) at an accelerating voltage of 200 kV. To prepare samples for Transmission Electron Microscopy [TEM], powders were ground in a mortar and pestle under acetone and transferred to a holey carbon grid.

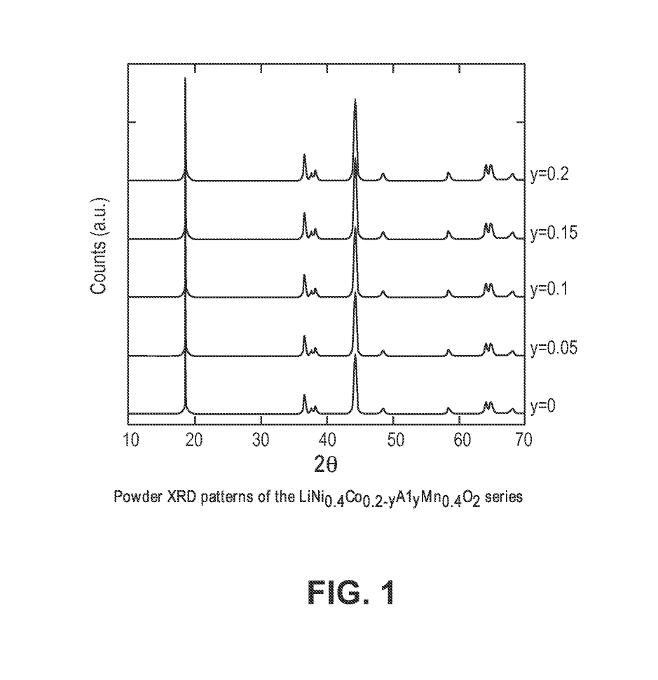

All materials were found to be phase pure by XRD powder diffraction (FIG. 1) and can be indexed in the R-3m space group for all values of y in Li[Ni_{0.4}Co_{0.2-y}Al_{y}Mn_{0.4}]O₂. The clear separation of the 018 and 110 peaks reveal the high degree of lamellar character of the materials. The distinct absence of any γ-LiAlO₂ impurities even at high y values indicates that a completely cobalt free solid solution material can be readily synthesized.

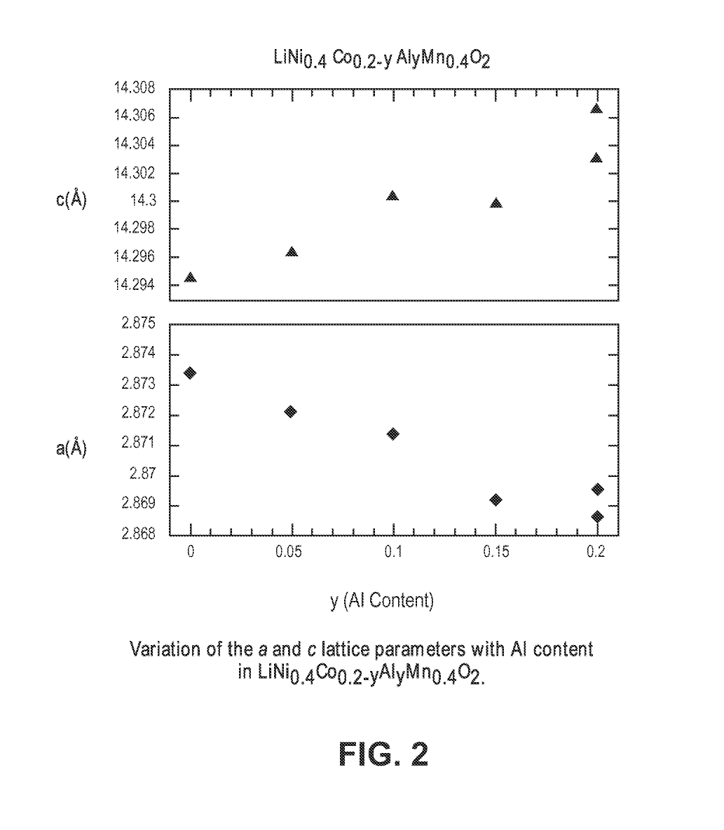

FIG. 2 shows the effect of Al substitution on the lattice parameters. Increasing Al content causes a decrease in the (a) parameter and a slight increase in the (c) parameter, leading to a minor decrease in the unit cell volume. The c/3a ratio can be taken as an indication of the degree of lamellarity. For a completely disordered structure with ideal cubic close packing (e.g., rock salt type), the c/3a ratio is 1.633 whereas, for a perfect layered structure with no ion-mixing such as LiTiS₂, the value is 1.793. The c/3a is influenced both by ion-mixing and by the magnitude of the LiO₂ slab spacing.

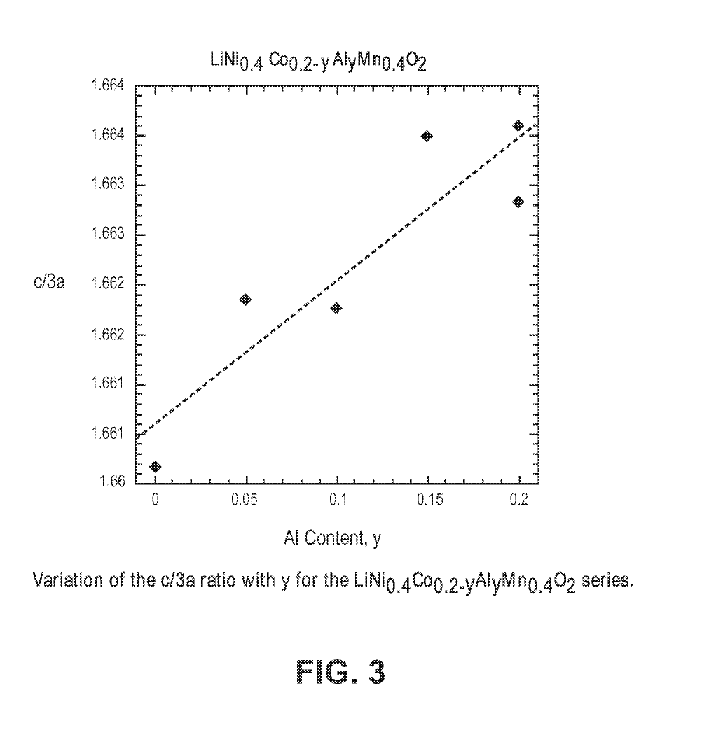

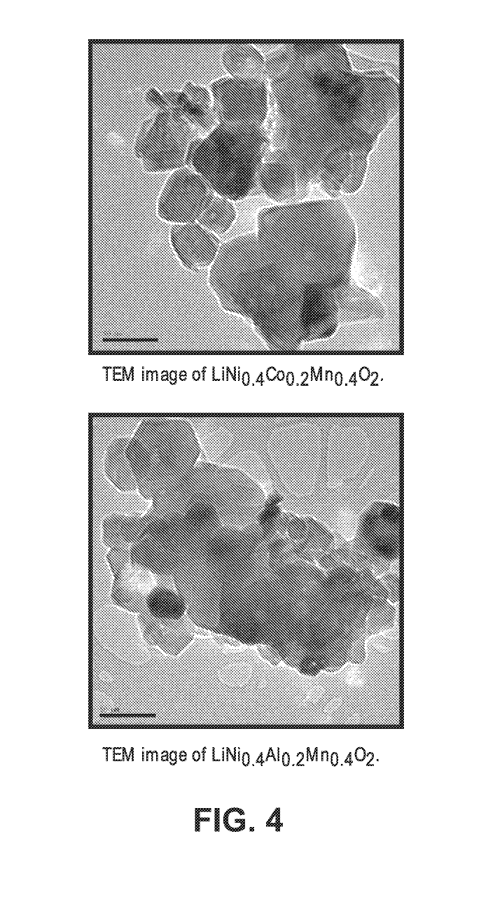

FIG. 3 shows that c/3a ratio increases slightly as Al content is increased, implying better lamellarity. However, all values are intermediate between those found for rock salt and ideal layered structures, implying that some nickel ions may still be located in lithium layers. Powders made by the glycine-nitrate combustion method are composed of small primary particles approximately 50 nm in diameter, with varying degrees of agglomeration (FIG. 4). Al substitution does not appreciably change the particle morphology.

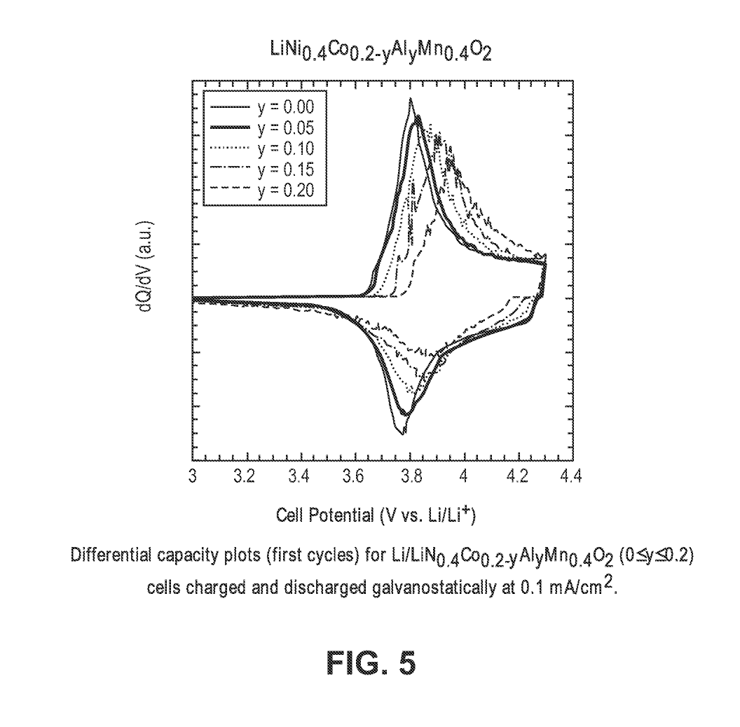

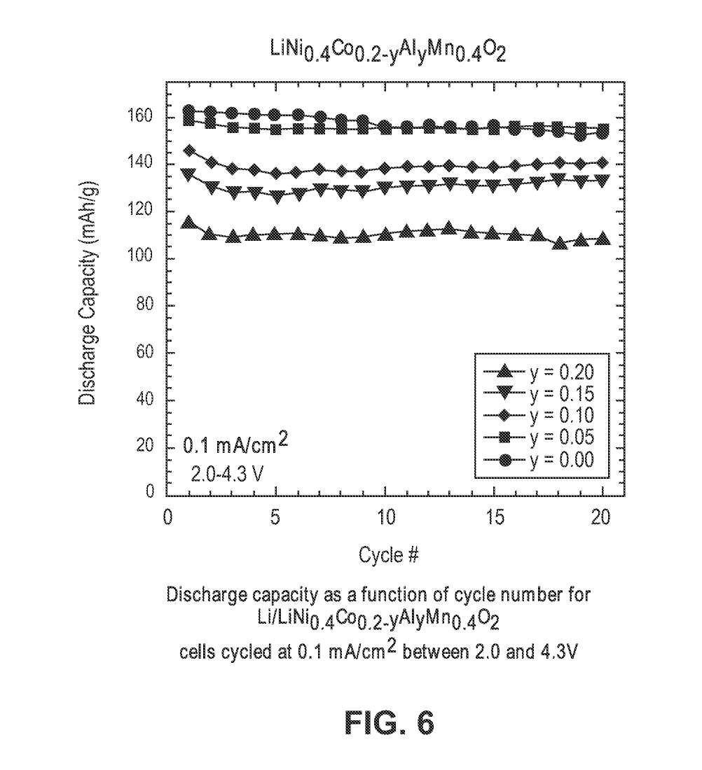

FIG. 5 shows differential capacity plots for Li/Li[Ni_{0.4}Co_{0.2-y}Al_{y}Mn_{0.4}]O₂ (0≦y≦0.2) cells charged and discharged at 0.1 mA/cm² between 2.0 and 4.3V. These results reveal that there is a progressive shifting of the peak potentials to higher values as the Al content is increased. This may account for the observed decrease in capacity as y increases (FIG. 6), for cells cycled between 2.0 and 4.3V. Although little Co is expected to undergo redox in this potential range, the low cutoff prevents full utilization because more capacity is shifted to a higher potential. Raising the upper voltage limit results in higher utilization initially for these electrodes but capacity fading is increased, possibly due to electrolyte oxidation. The best results of all the compounds tested in this voltage range were obtained for the composition y=0.05. The low Al substitution has an insignificant impact on the specific capacity obtained and the cycling behavior is marginally improved, so that, by the 15^{th} cycle, the Li[Ni_{0.4}Co_{0.15}Al_{0.05}Mn_{0.4}]O₂ electrode outperforms the unsubstituted material.

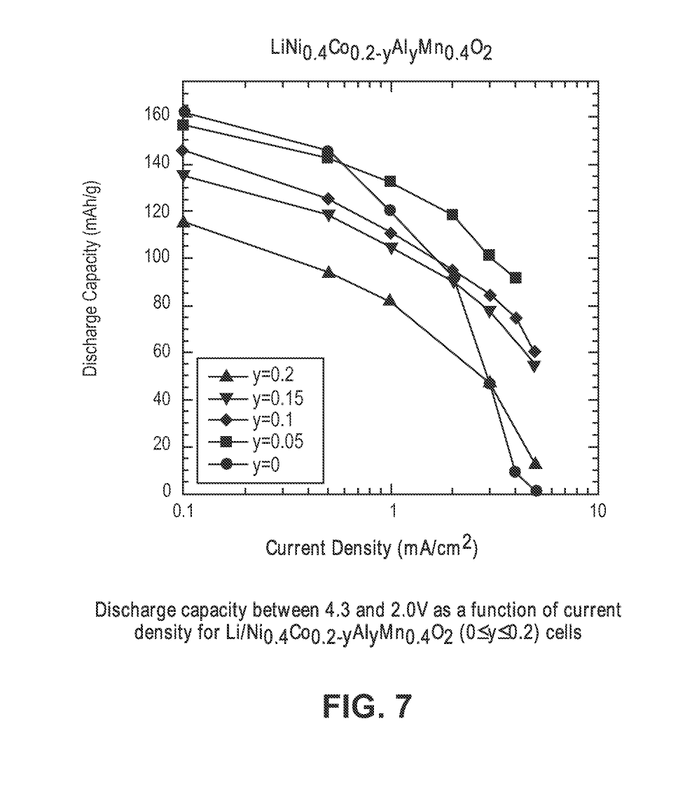

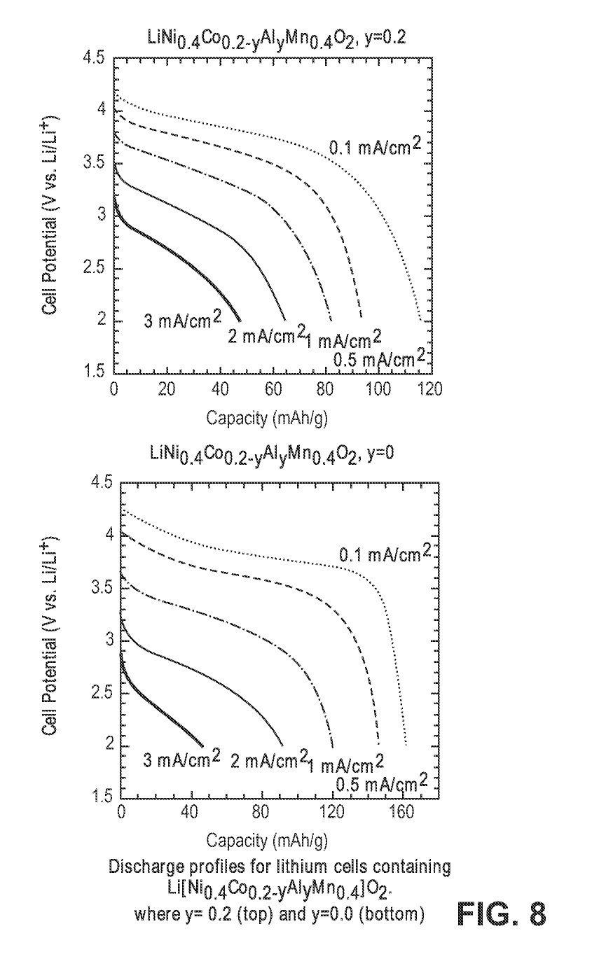

FIG. 7 shows the rate capabilities of Li/Li[Ni_{0.4}Co_{0.2-y}Al_{y}Mn_{0.4}]O₂ (0≦y≦0.2) cells discharged between 4.3 and 2.0V. All Al-substituted materials outperform the parent compound above certain critical current densities, which vary with the value of y. Li[Ni_{0.4}Co_{0.15}Al_{0.05}Mn_{0.4}]O₂ is clearly superior to Li[Ni_{0.4}Co_{0.2}Mn_{0.4}]O₂ at all current densities above 0.5 mA/cm², and still delivers over 100 mAh/g at 5 mA/cm² whereas Li[Ni_{0.4}Co_{0.2}Mn_{0.4}]O₂ cannot be discharged at all. Inspection of the discharge profiles indicates that cell polarization for the Al-substituted materials is much less than for the parent Li[Ni_{0.4}Co_{0.15}Al_{0.05}Mn_{0.4}]O₂ (see FIG. 8).

By way of this invention, it has been shown that phase-pure materials having the compositions Li[Ni_{0.4}Co_{0.2-y}Al_{y}Mn_{0.4}]O₂ (0<y≦0.2) can be prepared readily using the glycine-nitrate combustion synthesis method. Al substitution decreases the unit cell volumes slightly and increases the LiO₂ slab spacing, which helps Li ion diffusion, without substantially affecting the particle morphology. Although specific capacity in lithium cells between 4.3 and 2.0V is reduced in proportion to the amount of Al substitution in the materials, rate capability is enhanced considerably. The best-performing material has a composition of Li[Ni_{0.4}Co_{0.15}Al_{0.05}Mn_{0.4}]O₂, which delivers 160 mAh/g at 0.1 mA/cm² and 100 mAh/g at 5 mA/cm².

Substitution of part of the Co with Al in Li[Ni_{0.4}Co_{0.15}Al_{0.05}Mn_{0.4}]O₂ not only results in a marked improvement in the electrochemical performance over Li[Ni_{0.4}Co_{0.2}Mn_{0.4}]O₂, as it further reduces the Co content, lower costs are realized due to the lower raw materials costs of Al (approximately 1$/lb) compared to Co (about $50/lb). As an additional benefit, overcharge protection is afforded as Al is not electroactive, and thus not all of the lithium in the structure can be removed at the top of charge, affording a margin of safety in large battery systems. Metal oxides are often thermally unstable in the fully oxidized (delithiated) state because they release oxygen. Because Al is not redox active, not all the lithium can be removed from the cathode material if it is present. This improves the thermal stability (safety) because there is less likelihood that oxygen will evolve.

The Lithiated compounds of this invention are layered in that the transition metals and aluminum locate themselves in crystal planes which interleave themselves between planes of lithium atoms. Not intending to be bound by the following theory, the inventors believe that the improved results observed with the compositions of the invention are due in part to the fact that the presence of Al in the composition increases the LiO₂ slab spacing, which aids diffusion of Li ions through the structure.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself

We claim:

1. A composition of matter comprising;
Li[Ni_{0.4}Co_{0.2-y}Al_{y}Mn_{0.4}]O₂
wherein y is between greater than 0.00 and 0.20.

2. The composition of matter of claim 1 wherein y is between >0 and 0.05.

3. The composition of matter of claim 2 wherein y is 0.05.

4. The composition of claim 1 in which the material is layered.

5. An electrode for use in lithium ion batteries including as an electrode material Li[Ni_{0.4}Co_{0.2-y}Al_{y}Mn_{0.4}]O₂ wherein 0>y≧0.20.

6. The electrode of claim 4 wherein 0>y≧0.05.

7. The electrode of claim 5 wherein y=0.05.

8. A process for the manufacture of Li[Ni_{0.4}Co_{0.2-y}Al_{y}Mn_{0.4}]O₂ whereby stoichiometric amounts of soluble metal precursors are dissolved in a solvent, and then the solution is reduced in volume until it forms a gel, paste or powder.

9. The process of claim 8 wherein the solution is mixed with a fuel, and then heated until auto ignition occurs, the resulting solid wet or dry milled until a homogenous powder is obtained.

10. The process of claim 8 or 9 wherein the end product of those processes are heated for a period of time at 700° C.-1000° C. until crystallization of the material is completed.

11. A process for manufacture of Li[Ni_{0.4}Co_{0.2-y}Al_{y}Mn_{0.4}]O₂ including the steps of
a. mixing stiochiometric amounts of LiNO₃, Mn(NO₃)₂, Ni(NO₃)₂-6H₂O, and Al(NO₃)₃-9H₂O in a minimum amount of solvent to dissolve the constituents;
b. mixing the resulting mixture with a fuel which is soluble in said solvent;
c. heating the solution to concentrate it until ignition of the mixture occurs;
d. collecting the resulting power and ball milling it in acetone;
e. flowing nitrogen over the resulting mix to dry it; and,
f. thereafter, firing the dried mix for up to 4 hours at 800 C until a crystalline phase-pure powder is formed.

12. The mixed transition metal oxide produced by the process of claim 11.

13. The mixed transition metal oxide of claim 11 wherein y is between >0 and 0.05.

14. The mixed transition metal oxide of claim 13 wherein y is 0.05

15. The process of claim 11 wherein the fuel is glycine.

16. The process of claim 15 wherein the solvent is water.

17. A process for manufacture of Li[Ni_{0.4}Co_{0.2-y}Al_{y}Mn_{0.4}]O₂ including the steps of
a. mixing stiochiometric amounts of LiNO₃, Mn(NO₃)₂, Ni(NO₃)₂-6H₂O, and Al(NO₃)₃-9H₂O in a solvent to dissolve the constituents;
b. heating the solution to concentrate it to a high viscosity past or gel; and,
c. thereafter, heating at between 700° C. to 1000° C. until crystallization of the material is complete.

18. The process of claim 17 wherein the solvent is water.
